(19) United States
(12) Patent Application Publication
(10) Pub. No.: US 2015/0112717 A1
(43) Pub. Date: Apr. 23, 2015

(54) REAL TIME UPDATES FOR HEALTHCARE PATIENTS

(71) Applicants: Khaled Jamal Saleh, Springfield, IL (US); Lena Saleh, Springfield, IL (US); Jeremy Holcomb, Springfield, IL (US); Jeff Thomas, Springfield, IL (US)

(72) Inventors: Khaled Jamal Saleh, Springfield, IL (US); Lena Saleh, Springfield, IL (US); Jeremy Holcomb, Springfield, IL (US); Jeff Thomas, Springfield, IL (US)

(21) Appl. No.: 14/254,605

(22) Filed: Apr. 16, 2014

Related U.S. Application Data
(60) Provisional application No. 61/894,721, filed on Oct. 23, 2013.

(51) Int. Cl. G06F 19/00

(52) U.S. Cl. CPC G06F 19/322
USPC 705/3

(57) ABSTRACT

A system and method for providing real-time updates about the treatment and status of a healthcare patient to healthcare providers and family of the patient is provided. The present invention may include a plurality of portable computers. When treatment is being performed or a status update for a patient is desirable, the healthcare provider may send the information using a portable computer. Other healthcare providers and family may receive the information as a live update. The information may then be stored on a database.

### CROSS-REFERENCE TO RELATED APPLICATION

This application claims the benefit of priority of U.S. provisional application No. 61/894,721, filed Oct. 23, 2013, the contents of which are herein incorporated by reference.

### BACKGROUND OF THE INVENTION

The present invention relates to the healthcare industry and, more particularly, to real-time updates for healthcare patients.

The current healthcare electronic health records systems has disorganized management systems, and a lack of standardized and available data. The communications system is slow and ineffective, causing increased cycle time for patients and inefficient workflow for the hospital. Communication channels between physicians and nurses are hindered which results in increased medical error and increases costs. Current methods for real-time communication during the process of providing in-patient and out-patient care is time consuming and very inefficient.

As can be seen, there is a need for an improved system and method for real time updates of healthcare patients.

### SUMMARY OF THE INVENTION

In one aspect of the present invention, a method of providing updates regarding healthcare patients comprises: creating a patient file comprising identifying information about a healthcare patient; storing the patient file in a database; providing a plurality of portable computers comprising wireless connections to a plurality of healthcare providers; sending at least one real-time update comprising at least one of a treatment and a status of the healthcare patient from at least one of the plurality of portable computers to the remaining portable computers; and uploading the real-time updates to the patient file within the database.

These and other features, aspects and advantages of the present invention will become better understood with reference to the following drawings, description and claims.

### BRIEF DESCRIPTION OF THE DRAWINGS

FIG. 1 is a schematic view of the present invention;

FIG. 2 is a perspective view of a plurality of portable computers sending and receiving messages;

FIG. 3 is multiple views of different selection screens of the present invention;

FIG. 4 is a notification screen of the present invention; and

FIG. 5 is a process flow chart of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

Broadly, an embodiment of the present invention provides a system and method for providing real-time updates about the treatment and status of a healthcare patient to healthcare providers and family of the patient. The present invention may include a plurality of portable computers. When treatment is being performed or a status update for a patient is desirable, the healthcare provider may send the information using a portable computer. Other healthcare providers and family may receive the information as a live update. The information may then be stored on a database.

The present invention includes a software/hardware system that allows for efficient real-time communication between healthcare providers and patients/families. The present invention provides ongoing data exchange about the patient being treated in the various stages of treatment. The product improves logistics, patient flow and staff communication. The present invention increases accessibility to services, improves communication channels, and thus minimizes medical errors while improving quality of care. The communication device and software of the present invention may ultimately decrease costs to all parties while improving patient satisfaction. The present invention may provide real-time communication between members of the same healthcare team in a closed environment optimizing the team effectiveness and efficiency while improving patient satisfaction, wait-time and minimizing costs.

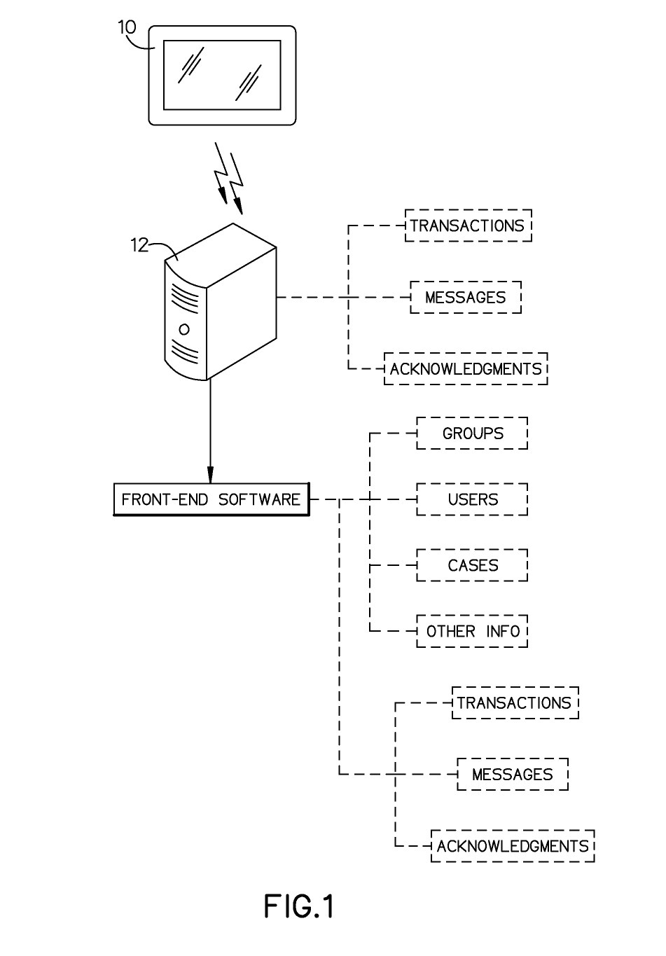

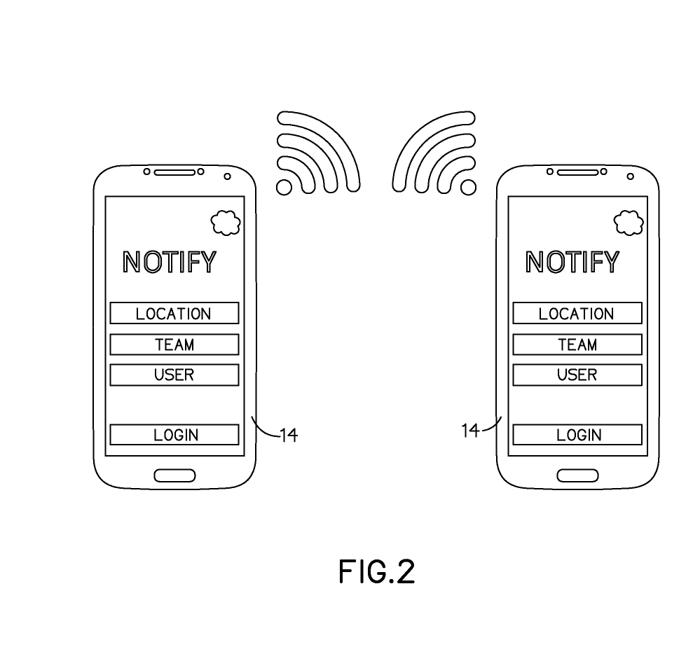

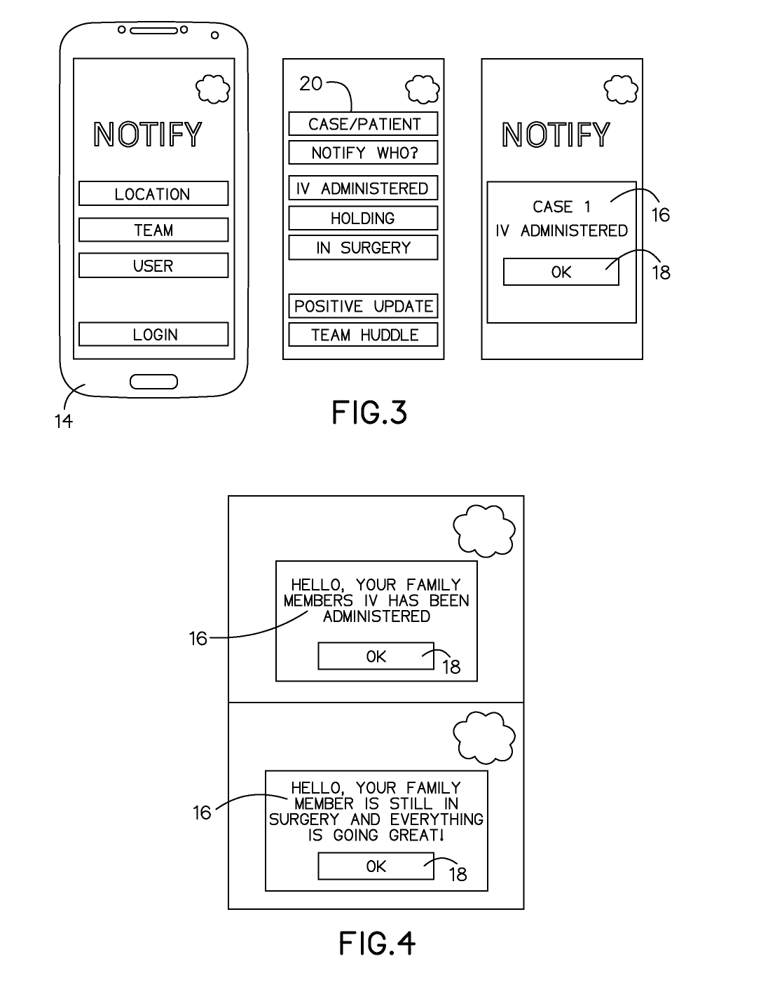

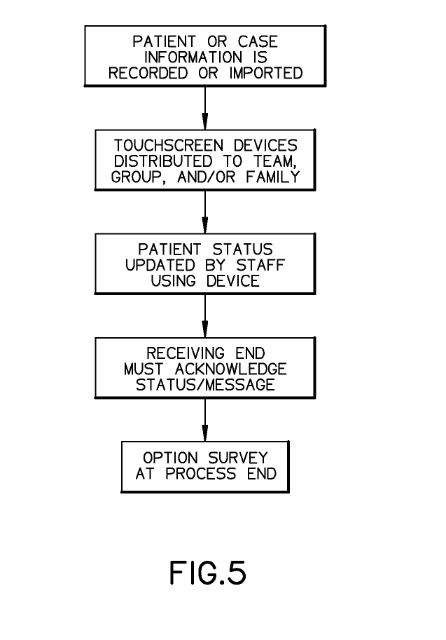

Referring to FIGS. 1 through 5, the present invention includes a system and method of providing updates regarding healthcare patients. A patient file may be created that includes identifying information about a healthcare patient. For example, employees of the healthcare providers may create a record of information, such as the patient or case, group or team designated to the patient, and the data maybe uploaded to a database 12, data warehouse or EHR system. In certain embodiments, the patient's information may be taken from another system or entered manually into the database 12.

The present invention may further include a plurality of portable computers 10 with software loaded onto the computers. The software of the present invention may include a front-end software component that is used for entering information such as groups, users, cases, and other information utilized by the present invention. The software of the present invention may further produce buttons, drop-downs, and inputs for uploading and accessing data, such as the client files of the database 12.

In certain embodiments, the plurality of portable computers 10 may include a touch screen and may have wireless communication capabilities. The plurality of portable computers 10 may be distributed to a plurality of healthcare providers and a plurality of family members. The portable computers 10 may be any portable computer, including but not limited to smart devices, such as tablets and smart phones.

The healthcare providers or family members may login 14 and access the patient file using the software application. The users may login 14 by entering at least one of a location of the patient, a username of the healthcare provider, and a team name of the team providing healthcare to the patient. For example, a login screen 20 may be provided so that the healthcare provider may select the case or patient, the person to notify, and a predetermined message. Once the healthcare provider is logged into the software, the healthcare provider may send a real-time update 16 which includes a message regarding either a treatment that is being provided to the patient or the status of the patient, i.e. any health related status updates.

In certain embodiments, when the a real-time updates 16 are sent, each portable computer 10 that is part of the team, group or family member may receive the real-time update 16. As mentioned above, the real-time updates may include selecting a predetermined message. Examples of the predetermined message may include IV administered, holding, in surgery, and the like. The predetermined messages are based on at least one of a type of treatment the patient is receiving, a location of the patient, and an identity of the healthcare provider selecting the message. If a real-time update 16 is sent, the messages may rotate to the next sequential message. The messages are uploaded into the database 12 and dynamic based on who the user is and the location of the patient. The healthcare provider may send the messages by utilizing buttons on the touch screen hardware device.

In certain embodiments, the recipients of the real-time updates 16 may be given a selection to acknowledge 18 receiving the real time update 16. The team, group or family member may acknowledge the message and the acknowledged message is be stored within the database 12. The messages sent and acknowledged may be archived in a database 12. The real-time updates 16 may be time stamped and chronologically saved within the patient file in the database 12.

Once the medical procedure is complete, a survey may be sent to a family member to complete and the results are stored in database. At anytime providers can view patient information utilizing their security PIN. Therefore, the software application may send a survey to the portable computer of the family member and once the survey is completed, the survey may be uploaded to the patient file within the database 12.

The following may include alternate embodiments of the present invention. The healthcare provider may login or be identified by the device utilizing or a user name and password. Multiple methods may be utilized for sending the messages, such as gestures, drop downs, text boxes, swiping, radio buttons, check boxes, or other methods of user input. Visual notifications on the screen, an voice notifications may be utilized, as well as text messaging, email or conveyed by phone.

The present invention may be utilized in any field that could benefit from immediate communication between two or more parties in an efficient manner. Since messages are dynamic, they may be fitted to conform with any need that the end user has. A byproduct of the present invention may include data that can be used for reporting and analysis. Reports could include, but not limited to, wait times, productivity, case load or volumes, patient or case list, patient satisfaction and scores or other information.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of providing updates regarding healthcare patients comprising:
creating a patient file comprising identifying information about a healthcare patient;
storing the patient file in a database;
providing a plurality of portable computers comprising wireless connections to a plurality of healthcare providers;
sending at least one real-time update comprising at least one of a treatment and a status of the healthcare patient from at least one of the plurality of portable computers to the remaining portable computers; and
uploading the real-time updates to the patient file within the database.

2. The method of claim 1, wherein the plurality of healthcare providers are members of a same team providing healthcare for the healthcare patient

3. The method of claim 1, further comprising the step of logging in to the patient file by entering at least one of a location of the patient, a username of the healthcare provider, and a team name prior to sending the real-time updates.

4. The method of claim 1, wherein the plurality of portable computers each comprise a touch screen.

5. The method of claim 1, wherein sending real-time updates comprises selecting predetermined messages, wherein the predetermined messages are based on at least one of a type of treatment the patient is receiving, a location of the patient, and an identity of the healthcare provider selecting the message.

6. The method of claim 1, further comprising the step of acknowledging receipt of the real time-update.

7. The method of claim 1, further comprising the step of time stamping the real-time updates and chronologically saving the real-time updates within the patient file in the database.

8. The method of claim 1, further comprising the step of providing at least one family member with a portable computer.

9. The method of claim 8, further comprising the step of sending a survey to the portable computer of the family member.

10. The method of claim 9, further comprising receiving the completed survey and saving the survey to the patient file.
